(19) United States
(12) Patent Application Publication
(10) Pub. No.: US 2007/0111171 A1
(43) Pub. Date: May 17, 2007

(54) Lenticular teaching and greeting card apparatus

(76) Inventor: Mary Kane, San Diego, CA (US)

Correspondence Address: Vern Schooley;Fulwider Patton Lee & Utecht, LLP, Suite 1550, 200 Oceangate, Long Beach, CA, 90802, US

(21) Appl. No.: 11/260,341

(22) Filed: Oct. 27, 2005

(51) Int. Cl. G09B 19/00

(52) U.S. Cl. 434/156; 434/112

(57) ABSTRACT

A sign language instructional device including a plurality of graphics corresponding with gestures in sign language to, when viewed a sequence covering a selected meaning, and positioned behind a lenticular lens to selectively display images of the graphics in sequence. The method includes this making on use of such a device.

### FIELD OF THE INVENTION

The present invention relates to a device to facilitate communication by sign language.

### BACKGROUND OF THE INVENTION

### Description of the Prior Art

Sign language is a well-developed multi-sensory form of communication immensely important to the deaf and hard of hearing population. A well-known form of sign language is the American Sign Language (ASL) and includes hand, arm, face and body gestures which are indicative of various letters of the English alphabet and even syllables and words themselves. ASL is the third most used language in the United States of America and, for the deaf and hard of hearing, is the first. Sign languages are known in many different languages and are a natural, rich, visual-gestural-spatial language developed over many centuries and relied on by many for daily communication. A communicator may sign with his or her mouth, arm, facial gestures or body language to communicate individual letters or entire thoughts.

Many languages, including English, have two forms—a spoken form and a written form. The spoken, audible word is momentary and audible to the ear. On the other hand, the written form of the language is relatively exact, static and permanent. Sign languages do not typically have a written form. Rather, they rely on picture drawings with arrows seeking to show movements to make the particular signs. Videos are helpful but do not completely parallel the written form. Like a spoken word sign language is momentary and when the movement of the hand or facial impression stops the visual image is gone. Thus, there exists a need for sign languages to be displayed in understandable multi-dimensional form similar to that of the written form of spoken languages along with that language in written form. It is this need to which the present invention is directed.

I have discovered that graphic gestures of sign language may be selectively transmitted through a lenticular screen in coordination with the affiliated written word to visually communicate both the gesture and the written word to thereby facilitate teaching of sign language or communication thereof.

Motion or image products are old and well-known. In some mediums, they employ a technology called lenticular printing that typically prints a group of lines or line segments which cooperate to define a graphic in alternating strips of each graphic on the back or behind a plastic sheet or screen. The plastic sheet incorporates a series of curved ridges called lenticules or lenticular lenses. When light is projected through the plastic sheet from their front side it will be reflected from a white or light colored surface on the backside thereof and about the printed graphic strips to refract the returning light a specific angles and to magnify the image. The printed image strips are aligned accurately so the strips for a particular graphic are refracted to project an image of the graphic to the same point for viewing by a viewer. The refraction and magnification causes the viewer to receive the projected image as a single composite image and, by shifting to different angles, such viewer will view the different images depending on the particular angle of viewing.

The production of lenticular lenses and is well-known and described in detail in various U.S. patents, including U.S. Pat. No. 5,967,032 to Bravenec et al. Generally, the process includes selecting segments from visual graphics to create a desired visual effect and interlacing the segments in accordance with the desired graphics. Lenticular lenses or lens sheets are then mapped to the interlaced segments or sets of graphic strips or the lenticular lenses fabricated according to this mapping.

The lenticular lenses produced are often employed in devices intended to display animated images. Examples include those disclosed in U.S. Pat. No. 3,628,239 to Finker; U.S. Pat. No. 2,832,593 and U.S. Pat. No. 3,119,195 to Braunhut as well as U.S. Pat. No. 3,586,592 to Cahn.

### SUMMARY OF THE INVENTION

The present invention includes a method employing a lenticular lens disposed over multiple graphic gestures corresponding with sign language gestures and to be selectively projected as images through the lens, depending on the angle of orientation, to display such images concurrent with the display of words syllables or phrases corresponding with the respective gestures. The invention also includes a display device including such a lens over the respective images and oriented as described along with a display panel for display of the text of the thought communicated by the gesture.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is a perspective view of a sign language display device incorporating the present invention;

FIG. 2 is a vertical sectional view, in enlarged scale, taken along the lines 2-2 thereof;

FIG. 3 is detail sectional view, in enlarged scale, taken from the circle 3 in FIG. 2;

FIG. 4 is a front view, in enlarged scale, of the device shown in FIG. 1 and depicting a symbolic view of a graphic to be projected from a card device;

FIG. 5 is front view similar to FIG. 4 but symbolic of a graphic to project a second image;

FIG. 6 is a front view of a second embodiment of the sign language instructional device of the present invention; and

FIG. 7 is a front view similar to FIG. 6 but depicting the device at a different angle relative the viewer.

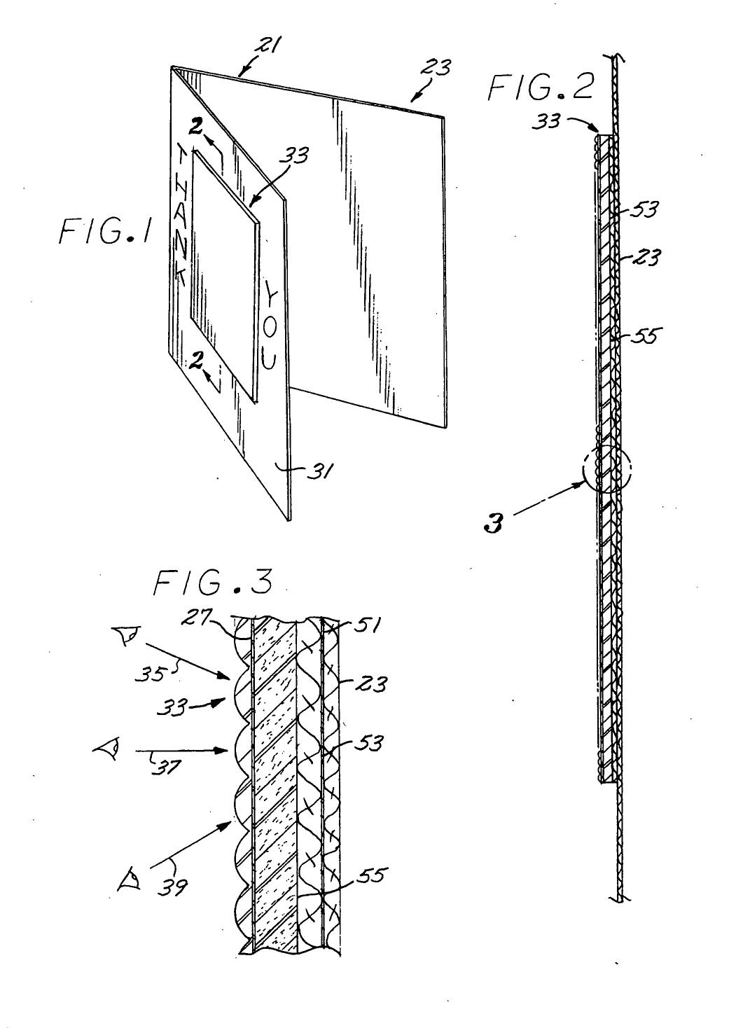

### DETAILED DESCRIPTION OF THE INVENTION

In the effective communication with sign language, many communicators express themselves with somewhat shorthand gestures involving dynamics where the communicator makes hand gestures or the like involving shifting the fingers, hands and/or arms through a series of positions indicative of a syllable of a word, or word phrases to be perceived by a viewer as a whole expressing a complete thought. While moving pictures, video images and the like may present certain benefits in replicating the gestures indicative of sign language words or phrases, such devices are relatively cumbersome to use, are not and are not acceptable for communicating reading messages or the like. Thus, it is important that the communicator have a facility which compactly packages multiple images for sequential display thereof to depict to the viewer images of a sequence of actions, preferably displayed in conjunction with printed or written words also expressing the meaning of the gestures. My present invention is directed to this solution.

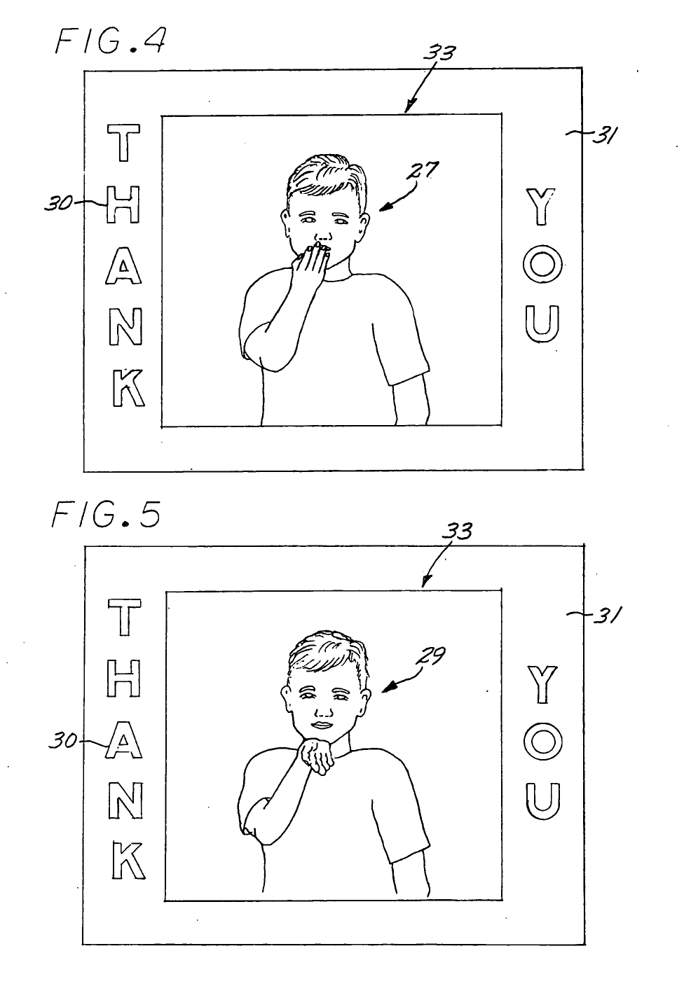

The preferred embodiment of my invention includes, generally, a card device 21 which may include paper stock 23 mounting a lenticular lens screen 33 carrying segmentations of individual graphics 27 and 29 of a person which, when displayed in sequence, exhibit the impression of, for instance, a hand movement from over the mouth as shown in FIG. 4 to a position extending outwardly and forward of the body shown in FIG. 5. A phrase, such as the words “Thank You” 30 may be printed on the face of the card 21 at a border location 31 for viewing concurrent with the image of the hand gestures depicted in FIGS. 4 and 5. The graphics 27 and 29 are covered by the lenticular screen 33 (FIG. 3) which includes lenticules operative to, when viewed from different angles 35, 37 and 39, display to the viewer a sequence of composite images of the graphics 27 shown in FIG. 4 to the graphic 29 shown in FIG. 5 thus presenting the viewer with the impression the hand is moving in progressive fashion from the location over the mouth to the extended position shown in FIG. 5. The viewer will then perceive the sequence of images as being a dynamic animation representative of the gesture in American Sign Language affiliated with the words “Thank You”. This when associated with the text “Thank You” introduces the viewer to a mental affiliation of the word with the animated gesture to thereby educate and, upon repeated viewing commit the meaning of the sign language to memory.

As will be appreciated by those skilled in the art, sign language involves a number of different formats. First, ASL convention involves hand signs associated with the various letters of the alphabet, such as a closed fist with the thumb touching the outer surface of the index finger for the letter “A” open palm with crossed thumb for the letter “B” and cup-shaped fingers and thumb for the letter “C”. ASL has developed to the point where short hand dynamic gestures are employed to indicate entire syllables or even entire words or phrases. These gestures normally involve movement and/or expressions to allow the viewer to observe the progression of the gesture which may involve shifting the hand and fore arm from one position through intermediate positions to a second position, all of which may be comprehended in the entirety, much as students learn read by observing the entire word, rather than sounding out the word letter by letter.

By placing multiple graphics depicting the gestures 27 and 29 (FIG. 4 and 5) and depicting the beginning and end of gesture and one or more intermediate graphics with the speakers at an intermediate position(s) between the position over the mouth as shown in FIG. 4 and the fully extended position shown in FIG. 29, and designing and positioning the lenticular lens 33 to display images of those graphics in sequence, the viewer will perceive movement. In the exemplary embodiment, the lenticules cooperate to display those graphics in sequence upon angling of the face of the card 21 for viewing first from an angle of about a -45° along the viewing axis 39 shown in FIG. 3 then straight through the viewing axis 37 and finally at a plus 45° angle for the viewing axis 35, so the human eye is exposed to a sequence of images which, in real time, appear to depict an animated continuous gesture with the hand moving from a position over the mouth as shown in FIG. 4 to the extended position shown in FIG. 5 thereby conveying to the viewer familiar with the sign language the expression “Thank You”. By simultaneously displaying the text 31 depicting the letter spelling “Thank You” a viewer even unfamiliar with ASL, will recognize that the animated gesture observed with inclination of the card as described above constitutes an expression meaning just that “Thank You”.

As noted above in the background section above, the construction of lenticular animation devices is well known in the art. As will be appreciated by those skilled in the art the device of the present invention may take many different forms, such as instructional boards or even books to display a sequence of gestures associated with various selected meanings or messages. In this regard, the construction may include a backing paper 23 over lied by a card stock 51 (FIG. 3) and secured thereto by a layer of adhesive 53 to support thereon a panel of lightweight stiffening foam 55. The front surface of the panel is of a white reflective finish for reflecting incoming light back through the lenticules of the lenticular screen. The back side of the screen 33 will be formed with interlaced graphics 27 and 29 on possibly more and broken into segments such that when viewed from the various angles will result in the viewer perceiving the graphic of the character making the gesture as having one, two, three or even more distinctive positions but, when so viewed, will be perceived as a more or less continuous motion thus suggesting dynamics and closely imitating a speaker expressing him or herself through ASL. As will be recognized, such graphics may be printed directly on the back of the screen, on the reflective screen or on a carrier sheet interposed therebetween, it being important only that such graphics be in the path of the reflected light so as to be projected to the viewer as an accurate image of the graphic. The graphic may be of any desired sign language such as an English, Spanish, German, Japanese or any other well recognized sign languages. The particular gestures shown in the exemplary embodiment are taken from American Sign Language but, of course could be from any other desirable sign language.

It should be understood that the term lenticular lens or lenticular screen is intended to encompass any lens mechanism to provide for sequential display of individual images whether presently known or to be developed in the future, including such screens to display high definition video, whether two or three dimensional.

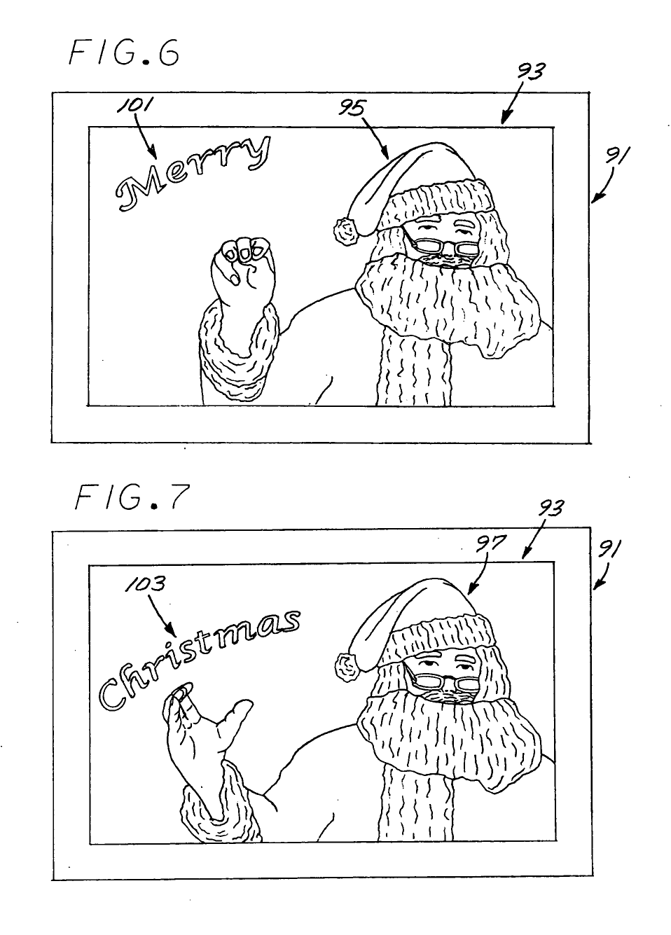

The second embodiment of the sign language instructional device of the present invention is shown in FIGS. 6 and 7 includes, generally, a backing card 91 having a lenticular lens screen 93 disposed thereover with a plurality of graphics 95 and 97 printed on the back side thereof to depict, for instance, a plurality of gestures and viewed in progression convey a sign language message such as “Merry Christmas”, “Happy Hanukkah” or the like. Also, displayed behind the lenticular screen 93 are printed words, such as for instance, the word Merry 101 as shown in FIG. 6 and word Christmas 103 as shown in FIG. 7. The graphics 95 and 97 are of the characters such as Santa Claus depict the communicator in a first position as shown in FIG. 6 with the right hand generally depicted with the thumb folded in and the fingers clasped thereover as is characteristic of a sign for the letter “M” but when displayed in a sequence, sometimes with other gestures will cooperate to mean, for instance, “Merry” used in the phrase “Merry Christmas”. In this regard, the gesture depicted by the graphic 97 in FIG. 7 shows the Santa Claus character with the fore arm upright to his side and the thumb and fingers curved in a gesture typically corresponding with the sign for the letter “C” but which, when viewed in combination cooperate in conveying the message “Merry Christmas”. In this regard, there may be two, three or even more static graphics comparable to graphics 95 and 97 which depict intermediate static positions of a gesturing character and which, when viewed in progressive sequence communicate a composite message. Here, the graphics 95 and 97 and the text words 101 and 103 are so positioned and configured that the lenticular lens 93 functions, when the backing 91 is in one angular position relative to the viewer, project the image of the graphic 95 and of the text 101 and when in a second angular position, project an image of the graphic 97 and text 103 so that the viewer will be viewing only the selected images of the graphics and text concurrently thereby allowing the viewer to, as the backing 91 is shifted from the angle shown on FIG. 6 to the angle shown in FIG. 7, comprehend the movement of the hand of the Santa Claus character from the position shown in FIG. 6 to the position shown in FIG. 7 thus affording a visual impression of a sign language message and the associated text message.

As will be appreciated by those skilled in the art, the backing 91 may take many different forms, including that of a greeting card, instructional display plate, page of a book or the like whereby a viewer could even read a few pages of a book in which the book itself could be manipulated through an arc to thus result in the respective lenticularly screened pages shifting through multiple positions to display multiple different images 95 and 97 conveying sign language in a progressive and continuous manner.

From the foregoing, it will be appreciated that the instructional sign language of the present invention and the method of its use provides a creative, convenient and inexpensive means for teaching or communication through sign language.

I claim:

1. A method of making an instructional device to facilitate instructing sign language, including:
selecting a plurality of graphics depicting selected static positions of a communicator and characteristic of incremental positions of a series of positions indicative of an expression operative to convey a selected meaning of the sign language;
selecting printed words also cooperating to convey the selected meaning;
selecting a backing;
placing a lenticular lens screen over a reflective optical area on the backing for, upon a viewer viewing the screen from a selected viewpoint and manipulating the backing and screen progressively through predetermined positions in an arc, transmitting light selectively from selected spaced apart sections in the optical area to the selected view point;
affixing the images in spaced relation behind the lenticular screen and so arranged and configured as to, upon the backing being manipulated for progressive viewing through in one direction through the selected angles, provide for selected projection of images of the graphics to the viewpoint;
placing the words on the backing for viewing from the view point concurrent with viewing of the optical area.

2. The method of claim 1 wherein:
the backing is selected as a greeting card; and
the meaning is selected as a greeting.

3. The method of claim 1 that includes:
placing the words adjacent the optical area.

4. The method of claim 1 that includes:
placing the words behind the screen positioned for selective display to the view point;
positioning the graphics behind the lenticular screen to be viewed from the viewpoint in the selected sequence as the backing is moved through the one direction through the arc;
selecting the words to express the respective plurality of meanings and placing the words behind the lenticular screen in position for being viewed through the lenticular screen from the view point in coordination with the respective graphics.

5. The method of claim 1 wherein:
the meaning is selected to express the phrase “Thank You”.

6. The method of claim 1 wherein:
the meaning is selected to express the phrase “Merry Christmas”.

7. An instructional device for instructing on the relationship between the meaning of a sign language gesture and a written word conveying an expression and comprising:
a backing including a reflective surface;
a lenticular screen on the backing including lens means constructed to, upon the backing being rotated through selected positions in an arc, reflect light from the reflective surface to a view point;
graphic means including graphic segments shaped to when viewed in a selected sequence to collectively indicate the meaning and, interposed between the lenticular lens screen and the reflective surface and operative to, upon rotation of the backing through the selected positions in the arc to divert corresponding segments of the reflected light to cooperate in projecting respective images of the graphic means to the viewpoint in the selected sequence; and
text means spelling the meaning and positioned on the backing for view from the viewpoint.

8. The device as set forth in claim 7 wherein:
the backing is selected to with a dimension of substantially 5½″×6″ so the device can serve as a greeting card.

9. The device as set forth in claim 7 wherein:
the backing includes a boarder adjacent the screen; and
the text means is positioned on the boarder.

10. The device as set forth in claim 7 wherein:
the text means is placed behind the screen and is so positioned as to the project selected portions thereof though the screen in coordination with the images of the respective graphic means.

11. A method of teaching sign language including:
selecting a teaching device including a plurality of interlaced images on a backing, the images, when viewed in a selected sequence being indicative of a sign language expression, the device including a lenticular screen configured to, upon the backing being rotated through selected angles, to project images of the selected graphics in the selected sequence; and
while projecting the images to a viewer, displaying a printed text of sign language associated with the gesture graphic.

12. The method of claim 11 that includes:
selecting the backing to include the printed text displayed thereon.

13. The method of claim 11 wherein:
the images are selected from ASL.

14. A sign language instructional device comprising:
a backing including a reflective surface;
a lenticular lens screen on the backing and operative upon the backing being rotated through selected positions in an arc to relative light from the reflective surface to a view point;
a plurality of graphics on the back side of the lenticular screen and collectively indicative of a gesture corresponding with selected sign language meaning and operative to upon rotation of the backing to the selected positions to reflect light from the surface to the view point to carry images of the graphics to a viewer at the view point to thereby convey the impression of the sign language meaning.

15. The device of claim 14 that includes:
a text on the backing conveying the meaning of the gesture.

16. The device of claim 14 wherein:
the graphics are selected from ASL.

17. The device of claim 14 wherein:
the graphics are selected from an English sign language.
